(19) United States
(12) Patent Application Publication
(10) Pub. No.: US 2022/0242634 A1
(43) Pub. Date: Aug. 4, 2022

(54) COVER FILM AND ELECTRONIC COMPONENT PACKAGE USING SAME

(71) Applicant: DENKA COMPANY LIMITED, Tokyo (JP)

(72) Inventors: Takanori ATSUSAKA, Tokyo (JP); Saori NIWA, Tokyo (JP); Takeshi SAITOH, Tokyo (JP)

(73) Assignee: DENKA COMPANY LIMITED, Tokyo (JP)

(21) Appl. No.: 17/623,775

(22) PCT Filed: Jul. 3, 2020
(86) PCT No.: PCT/JP2020/026205

§ 371 Date: Dec. 29, 2021

(30) Foreign Application Priority Data
Jul. 11, 2019 (JP) 2019-128925

(51) Int. Cl. B65D 65/40; B32B 27/38; B32B 27/08; B32B 27/32; B32B 27/30; B32B 27/20

(52) U.S. Cl. CPC B65D 65/40; B32B 27/38; B32B 27/08; B32B 2435/02; B32B 27/306; B32B 27/20; B32B 27/32

(57) ABSTRACT

A cover film having at least a substrate layer and a sealant resin layer, wherein the sealant resin layer is formed to contact one surface of the substrate layer or is formed on an intermediate resin layer contacting one surface of the substrate layer, and the sealant resin layer contacting the substrate layer or the intermediate resin layer contacting the substrate layer contains an epoxidized fatty acid or a derivative thereof. The epoxidized fatty acid or a derivative thereof in the sealant resin layer contacting the substrate layer or in the intermediate resin layer contacting the substrate layer is preferably at a content of 0.5 parts by mass or less with respect to 100 parts by mass of a resin component constituting the intermediate resin layer contacting the substrate layer and/or the sealant resin layer contacting the substrate layer.

### TECHNICAL FIELD

The present invention relates to a cover film and an electronic component package using the same.

### BACKGROUND

Alongside the miniaturization of electronic devices, the miniaturization and performance of the electronic components used have also improved and components are automatically mounted on printed boards in assembly processes for electronic devices. Surface-mounting electronic components are stored in a carrier tape in which pockets are continuously formed by thermoforming in accordance with the shapes of the electronic components. After the electronic components are stored, a cover film is laid as a lid material on an upper surface of the carrier tape and both edges of the cover film are continuously heat sealed in the longitudinal direction with a heated seal bar to form a package.

A configuration in which a sealant resin layer is formed, via an intermediate resin layer as necessary, on a substrate layer including a polyester film, etc. is known as the general configuration for cover films. As methods for forming the intermediate resin layer or the sealant resin layer on the substrate layer, conventional methods (e.g., Patent Document 1) involving preliminarily applying an anchor coating agent containing a urethane resin, an ethylene vinyl acetate copolymer resin (EVA), etc. onto the substrate layer and on the applied surface thereof, forming the intermediate resin layer or sealant resin layer are known. However, when using an anchor coating agent, there were problems of increased workload, increased costs, as well as environmental pollution due to the organic solvent contained in the anchor coating agent.

### CITATION LIST

### Patent Literature

Patent Document 1: JP 2018-118766 A

### SUMMARY OF THE INVENTION

### Technical Problem

The present invention addresses the problem of providing: a cover film with excellent interlayer adhesiveness without using an anchor coating agent; and an electronic component package using the same.

### Solution to Problem

The present invention relates to the following.

(1) A cover film having at least a substrate layer and a sealant resin layer, wherein the sealant resin layer is formed in contact with one surface of the substrate layer or is formed on an intermediate resin layer contacting one surface of the substrate layer, and the sealant resin layer contacting the substrate layer or the intermediate resin layer contacting the substrate layer contains an epoxidized fatty acid or a derivative thereof.

(2) The cover film described in (1), wherein the epoxidized fatty acid or a derivative thereof in the sealant resin layer contacting the substrate layer or in the intermediate resin layer contacting the substrate layer is at a content of 0.5 parts by mass or less with respect to 100 parts by mass of a resin component constituting the sealant resin layer contacting the substrate layer or the intermediate resin layer contacting the substrate layer.

(3) The cover film described in (1) or (2), wherein the intermediate resin layer contains a polyethylene resin.

(4) The cover film described in (3), wherein the polyethylene resin has a density of 0.85-0.95 g/cm³ as measured in accordance with a JIS K7112 measurement method.

(5) The cover film described in any one of (1) to (4), wherein the sealant resin layer contains one or more selected from the following [1] to [3]:

[1 ] a resin composition that contains a styrene-diene block copolymer-containing styrene-based resin and an ethylene-α-olefin random copolymer;

[2] a hydrogenated product of an aromatic vinyl-conjugated diene copolymer containing 15-45 mass % of an aromatic vinyl-derived monomer unit;

[3] an ethylene-vinyl acetate copolymer containing 70-91 mass % of an olefin component.

(6) The cover film described in any one of (1) to (5), wherein the substrate layer contains one or more selected from a biaxially stretched polyester and a biaxially stretched polypropylene.

(7) The cover film described in any one of (1) to (6), wherein a surface of the substrate layer, which does not contact the sealant resin layer or the intermediate resin layer, and/or a surface of the sealant resin layer, which does not contact the substrate layer or the intermediate layer, contains an anti-static material.

(8) The cover film described in (7), wherein the anti-static material contains one or more selected from a surfactant, tin oxide, zinc oxide, titanium oxide, and carbon black, and the surface containing the anti-static material has a surface resistance of 1×10¹³Ω/□(ohms per square) or less.

(9) Use of the cover film described in any one of (1) to (8) as a lid material for a carrier tape containing a thermoplastic resin.

(10) An electronic component package having: a lid material using the cover film described in any one of (1) to (8); and carrier tape using a thermoplastic resin.

### Effects of Invention

According to the present invention, it is possible to provide: a cover film with excellent interlayer adhesiveness without using an anchor coating agent; and an electronic component package using the same.

### BRIEF DESCRIPTION OF DRAWINGS

FIG. 1 is a schematic sectional view showing the layer configuration of a cover film of a first embodiment of the present invention.

FIG. 2 is a schematic sectional view showing the layer configuration of a cover film of a second embodiment of the present invention.

FIG. 3 is a schematic sectional view showing another layer configuration of the cover film of the second embodiment of the present invention.

### DESCRIPTION OF EMBODIMENTS

Below, one embodiment of the present invention is described in detail, but in cases where the specific explanation provided for one embodiment applies to another embodiment, the corresponding explanation for the other embodiment is omitted. Moreover, the present invention is not limited to the following embodiment and can be carried out with modifications as appropriate so long as the effects of the invention are not inhibited.

The cover film according to one embodiment of the present invention has a substrate layer and a sealant resin layer. The sealant resin layer may be formed on the substrate layer to contact one surface of the substrate layer and may also be formed via an intermediate resin layer contacting one surface of the substrate layer. Below, the embodiment in which a sealant resin layer is formed in contact with one surface of a substrate layer may be referred to as the first embodiment, and the embodiment in which a sealant resin layer is formed on an intermediate resin layer contacting one surface of a substrate layer (i.e., the sealant resin layer is formed on the substrate layer via the intermediate resin layer) may be referred to as the second embodiment.

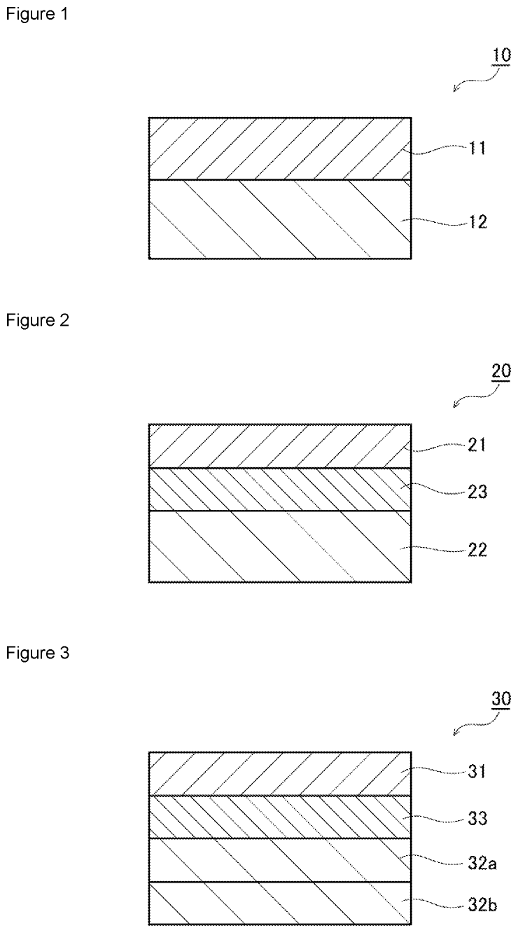

FIG. 1 is a schematic sectional view showing the layer configuration of the cover film according to the first embodiment. In this cover film 10, a sealant resin layer 12 is provided to contact one surface of a substrate layer 11. Moreover, in FIG. 1, the sealant resin layer 12 is provided in only one layer but may have two or more layers of different thicknesses and/or compositions laminated.

FIG. 2 is a schematic sectional view showing the layer configuration of the cover film according to the second embodiment. In this cover film 20, a sealant resin layer 22 is provided on a substrate layer 21 via an intermediate resin layer 23 provided to contact one surface of the substrate layer 21. Moreover, in FIG. 2, the sealant resin layer 22 is provided in only one layer but may have two or more layers of different thicknesses and/or compositions laminated (see FIG. 3). FIG. 3 is a schematic sectional view showing the layer configuration of the cover film according to the second embodiment when the sealant resin layer has a two-layer structure (reference signs 32a, 32b). In FIGS. 1-3, the sealant resin layers 12, 22, 32a, 32b are formed on only one surface of the substrate layers 11, 21, 31 but may be formed, as necessary, on both surfaces of the substrate layers 11, 21, 31. In this situation, the layer configuration on one surface side of the substrate layers 11, 21, 31 may be identical to or different from the layer configuration on the other surface side. Examples of cases in which the layer configurations are different include cases in which the substrate layer has the layer configuration according to the first embodiment on one surface side and the layer configuration according to the second embodiment on the other surface side.

(Substrate Layer)

The substrate layer is a layer that serves as a substrate for the cover film and is usually formed using a thermoplastic resin. That is, the substrate layer contains a thermoplastic resin. Examples of the thermoplastic resin constituting the substrate layer include polyester-based resins such as polyethylene terephthalate and polyethylene naphthalate; polyolefin-based resins such as polyethylene and polypropylene; polyamide resins such as 6,6-nylon and 6-nylon; etc. The layer can be formed by using a stretched product or a non-stretched product of a resin containing one or more selected from the foregoing.

Among the foregoing, the layer is preferably formed using one or more selected from a biaxially stretched polyester such as a biaxially stretched polyethylene terephthalate (PET) or a biaxially stretched polyethylene naphthalate (PEN); a biaxially stretched polypropylene; and a biaxially stretched nylon. In terms of high rigidity and transparency, the layer is more preferably formed using a biaxially stretched polyester or a biaxially stretched polypropylene.

The substrate layer preferably has an average thickness of 5-100 μm, more preferably 10-80 μm, and even more preferably 12-30 μm. By setting the thickness of the substrate layer to 5 μm or more, the tensile strength of the cover film itself becomes low, thereby enabling the suppression of “film rupture” occurrences when the cover film is peeled. Meanwhile, by setting the thickness to 100 μm or less, it is possible to suppress reductions in heat sealing properties for the carrier tape and increases in costs. In addition, the “average thickness” of each of the layers herein, such as the substrate layer, the intermediate resin layer, and the sealant resin layer, is the average value of measurements made at five points from a sectional observation using a scanning electron microscope (SEM) and may be described simply as “thickness” below.

(Sealant Resin Layer)

The sealant resin layer is a layer having an effect of heat sealing to a carrier tape. An electronic component package having a lid material using the cover film and carrier tape using a thermoplastic resin is made by heat sealing the sealant resin layer of the cover film to the carrier tape.

The sealant resin layer is formed using a thermoplastic resin. That is, the sealant resin layer contains a thermoplastic resin. Examples of the thermoplastic resin include olefin-based resins, styrene-based resins, butadiene-based resins, acrylic resins, polyvinyl chloride-based resins, polyester-based resins, and any one of the hydrogenated products thereof or combinations thereof.

As the thermoplastic resin, it preferably contains one or more selected from a resin composition containing a styrene-based resin and an ethylene-α-olefin random copolymer; a hydrogenated product of an aromatic vinyl-conjugated diene copolymer; an ethylene-vinyl acetate copolymer; etc.

The thermoplastic resin more preferably contains one or more selected from the following [1]-[3]. It is even more preferable that one or more selected from the following [1]-[3] be contained at a total of 50 mass % or more, 60 mass % or more, or 70 mass % or more among the components constituting the sealant resin layer.

[1] a resin composition that contains a styrene-diene block copolymer-containing styrene-based resin and an ethylene-α-olefin random copolymer

[2] a hydrogenated product of an aromatic vinyl-conjugated diene copolymer containing 15-45 mass % of an aromatic vinyl-derived monomer unit

[3] an ethylene-vinyl acetate copolymer containing 70-91 mass % of an olefin component

[1] Resin Composition that Contains a Styrene-Based Resin and an Ethylene-α-Olefin Random Copolymer

The styrene-based resin preferably contains a styrene-diene block copolymer as a main component. A “main component” herein refers to a component with a content of 50 mass % or more of the whole.

The styrene-diene block copolymer is a block copolymer with a styrene-derived monomer unit and a diene-derived monomer unit as essential units and has a polystyrene chain and a polydiene chain. Examples of the styrene-derived monomer unit include p-methylstyrene, m-methylstyrene, o-methylstyrene, o-t-butylstyrene, m-t-butylstyrene, p-t-butylstyrene, p-chlorostyrene, o-chlorostyrene, etc. For the styrene-derived monomer units, one or a combination of two or more may be used. Examples of the diene-derived monomer unit include conjugated diene-derived monomer units, e.g., butadiene, isoprene, etc.

Specific examples of the styrene-diene block copolymer include diblock copolymers of styrene and butadiene, styrene-butadiene-styrene triblock copolymers, block copolymers of styrene and isoprene, styrene-isoprene-styrene triblock copolymers, etc. and it is preferable that one or more selected from the foregoing be contained. Among the foregoing, diblock copolymers of styrene and butadiene are preferable in terms of heat sealing properties.

The styrene-based resin can contain, as another component, a styrene-based resin such as a general-purpose polystyrene or a high-impact polystyrene at a proportion of less than 50 mass %, 30 mass % or less, or 10 mass % or less among the resin components.

Examples of the α-olefin-derived monomer unit in the ethylene-α-olefin random copolymer include monomer units such as propylene, 1-butene, 2-methyl-1-propene, 2-methyl-1-butene, 3-methyl-1-butene, 1-hexene, 2-ethyl-1-butene, 2,3-dimethyl-1-butene, 1-pentene, 2-methyl-1-pentene, 3-methyl-1-pentene, 4-methyl-1-pentene, 3,3-dimethyl-1-butene, 1-heptene, methyl-1-hexene, dimethyl-1-pentene, ethyl-1-pentene, trimethyl-1-butene, methylethyl-1-butene, 1-octene, methyl-1-pentene, ethyl-1-hexene, dimethyl-1-hexene, propyl-1-heptene, methyethyl-1-heptene, trim ethyl-1-pentene, propyl-1-pentene, diethyl-1-butene, 1-nonene, 1-decene, 1-undecene, and 1-dodecene. For the ethylene-α-olefin copolymer, a combination of two or more may be used.

The content ratio of the styrene-diene block copolymer and the ethylene-α-olefin random copolymer is preferably 95/5 to 40/60 and more preferably 80/20 to 55/45 as a mass ratio of (styrene-diene block copolymer)/(ethylene-α-olefin random copolymer). By setting within the above ranges, the cover film, when peeled, has a small variation in peel strength and can be suitably used.

[2] Hydrogenated Product of Aromatic Vinyl-Conjugated Diene Copolymer

The hydrogenated product of an aromatic vinyl-conjugated diene copolymer is a copolymer containing: an aromatic vinyl-derived monomer unit; and a unit in which the double bonds of a conjugated diene-derived monomer unit have been hydrogenated and made into single bonds.

Examples of the aromatic vinyl-derived monomer unit include units derived from various styrene-based monomers, such as styrene and various substituted styrenes, e.g., p-methylstyrene, m-methylstyrene, o-methylstyrene, o-t-butylstyrene, m-t-butylstyrene, p-t-butylstyrene, p-chlorostyrene, o-chlorostyrene, etc. Among the foregoing, styrene units, p-methylstyrene units, and p-chlorostyrene units are preferable, and styrene units are particularly preferable. For these aromatic vinyl-derived monomer units, one or a combination of two or more may be used.

Examples of the conjugated diene-derived monomer units include units derived from conjugated diene monomers such as butadiene, isoprene, 1,3-pentadiene, and 2,3-dimethyl-1,3-butadiene. Among the foregoing, butadiene units and isoprene units are preferable. For these conjugated diene monomer units, one or a combination of two or more may be used.

Specific examples of the hydrogenated product of an aromatic vinyl-conjugated diene copolymer include a hydrogenated product of a diblock copolymer of styrene and butadiene, a hydrogenated product of a styrene-butadiene-styrene triblock copolymer, a hydrogenated product of a block copolymer of styrene and isoprene, a hydrogenated product of a styrene-isoprene-styrene triblock copolymer, etc. In terms of suppressing variations in peel strength when the cover film is peeled, a hydrogenated product of a styrene-butadiene-styrene triblock copolymer is preferable.

The content of the aromatic vinyl-derived monomer unit constituting the hydrogenated product of an aromatic vinyl-conjugated diene copolymer is preferably 15-45 mass % and more preferably 25-35 mass % in terms of being able to better reduce variations in peel strength when the cover film is peeled. With respect to the content of the unit in which the double bonds of a conjugated diene monomer unit have been hydrogenated and made into single bonds, it may be the total amount excluding the aromatic vinyl monomer unit. However, from the perspective of productivity, it is difficult to make all of the double bonds in conjugated diene monomer units into single bonds with the hydrogenation process, so as a range that does not impair the effects of the invention, the conjugated diene monomer units, if at 20 mass % or less, can be contained in the hydrogenated block copolymer.

The fluidity of the hydrogenated product of the aromatic vinyl-conjugated diene copolymer is not particularly limited but has a value of 1 g/10 min to 20 g/10 min and preferably 3 g/10 min to 10 g/10 min as measured at a temperature of 230° C. and a load of 2.16 kg in a JIS K7210 measurement method.

[3] Ethylene-Vinyl Acetate Copolymer

The ethylene-vinyl acetate copolymer is a copolymer with an ethylene-derived monomer unit and a vinyl acetate-derived monomer unit as essential units. In the ethylene-vinyl acetate copolymer, the olefin component preferably has a content of 70-91 mass % and more preferably 75-88 mass %. By setting the content of the olefin component within the preferable range of 70-91 mass % and the more preferable range of 75-88 mass %, heat sealing properties can be better expressed. Moreover, even when the cover film is exposed to a high-temperature environment, it is possible to prevent adhesion to the carrier tape at locations other those heat sealed from occurring.

The sealant resin layer preferably has an average thickness of 5-50 μm and more preferably 10-40 μm. By setting the thickness of the sealant resin layer to within the preferable range of 5-50 μm and the more preferable range of 10-40 μm, it is possible to better increase adhesiveness to the carrier tape while maintaining transparency. Moreover, the sealant resin layer can acquire effects such as being able to exhibit an adequate peel strength, being able to suppress increased costs, and being able to suppress variations in peel strength when the cover film is peeled. In addition, when the sealant resin layer has two or more layers laminated, the average thickness after lamination is preferably within the above ranges.

The sealant resin layer may have an inorganic filler added therein. The cover film, in a state of being heat sealed to a surface of carrier tape with electronic components therein, may be subjected to a baking treatment under conditions of about 24 hours in an environment of 80° C. or 72 hours in an environment of 60° C. in order to remove the moisture contained in the sealing resin. In this situation, if the contents, i.e., the electronic components, adhere to the cover film, that could cause problems during the process of peeling the cover film and mounting the electronic components. If an inorganic filler is added in the sealant resin layer, it is possible to prevent the electronic components from attaching to the cover film even when a baking treatment is performed.

The inorganic filler is not particularly limited, but examples thereof include spherical or crushed talc particles, silica particles, alumina particles, mica particles, calcium carbonate, magnesium carbonate, etc. A masterbatch in which the foregoing is dispersed in a binder resin can also be used. In terms of maintaining the transparency of the cover film, the inorganic filler preferably has a median diameter (D50) of less than 200 nm and for example, can be contained at 10-50 parts by mass with respect to 100 parts by mass of the resin component constituting the sealant resin layer. When used as a masterbatch, the content can be the above with respect to 100 parts by mass of the resin component including the binder resin.

(Intermediate Resin Layer)

The intermediate resin layer is a layer that may be formed between the sealant resin layer and the substrate layer. By providing an intermediate resin layer, the adherence between the sealant resin layer and the carrier tape can be increased when the cover film is heat sealed to the carrier tape.

The intermediate resin layer preferably contains a polyolefin-based resin as a main component. The term “main component” is as described above. Examples of the polyolefin-based resin include low-density polyethylene, linear low-density polyethylene, ultra low density polyethylene, epoxy-modified polyethylene or ethylene-1-butene copolymers, ethylene-vinyl acetate copolymers, ethylene-acrylic acid ester copolymers, ethylene-maleic acid copolymers, styrene-ethylene graft copolymers, styrene-propylene graft copolymers, styrene-ethylene-butadiene block copolymers, propylene polymers, ethylene polymers, etc., and blends thereof. It is possible to use the foregoing alone and it is also possible to use a plurality thereof in combination.

Among the foregoing, linear low-density polyethylene (hereafter indicated as LLDPE) with flexibility, moderate rigidity, and excellent tear strength at room temperature can be suitably used. In particular, by using a resin with a density within the range of 0.85-0.95 g/cm³ and the more preferable range of 0.900-0.925 g/cm³, extrusion of the intermediate resin layer resin from ends of the cover film, caused by the heat or pressure during heat sealing, hardly occurs, so contamination of the iron during heat sealing hardly occurs and the intermediate resin layer softens when the cover film is heat sealed, thereby alleviating contact unevenness of the heat sealing iron, and therefore a stable peel strength when the cover film is peeled is easily obtained. In addition, density is a value measured in accordance with a JIS K7112 measurement method.

In LLDPEs, there are those polymerized by a Ziegler type catalyst and those polymerized by metallocene-based catalysts (hereafter indicated as m-LLDPE). The molecular weight distribution of m-LLDPEs is narrowly controlled and they therefore have a particularly high tear strength and can be suitably used as the intermediate resin layer in the present invention. The m-LLDPE is a copolymer of ethylene and an olefin having at least three carbon atoms as a comonomer, preferably a linear, branched, or aromatic core-substituted α-olefin with 3-18 carbon atoms. Examples of linear monoolefins include propylene, 1-butene, 1-pentene, 1-hexene, 1-octene, 1-nonene, 1-decene, 1-dodecene, 1-tetradecene, 1-hexadecene, 1-octadecene, etc. Further, examples of branched monoolefins include 3-methyl-1-butene, 3-methyl-1-pentene, 4-methyl-1-pentene, 2-ethyl-1-hexene, etc. Moreover, examples of aromatic core-substituted monoolefins include styrene, etc. These comonomers can be copolymerized with ethylene alone or in a combination of two or more. In this copolymerization, copolymerization with a polyene such as butadiene, isoprene, 1,3-hexadiene, dicyclopentadiene, or 5-ethylidine-2-norbornene may be performed. Among the foregoing, those using 1-hexene or 1-octene as the comonomer have a high tensile strength and are also excellent in terms of costs and thus can be suitably used.

In terms of being able to increase the adherence between the sealant resin layer and the carrier tape while maintaining transparency, the intermediate resin layer preferably has an average thickness of 10-40 μm, more preferably 10-30 μm, and possibly 15-30 μm.

(Epoxidized Fatty Acid or Derivative Thereof)

In the cover film according to one embodiment of the present invention, the layer (intermediate resin layer or sealant resin layer) contacting the substrate layer contains an epoxidized fatty acid or a derivative thereof. In other words, when the sealant resin layer is formed to directly contact the substrate layer (first embodiment), the sealant resin layer contains an epoxidized fatty acid or a derivative thereof. When the sealant resin layer is formed to indirectly contact the substrate layer via the intermediate resin layer (second embodiment), the intermediate resin layer contains an epoxidized fatty acid or a derivative thereof. By including an epoxidized fatty acid or a derivative thereof in the layer (intermediate resin layer or sealant resin layer) contacting the substrate layer, it is possible to maintain transparency and increase the adhesiveness between the substrate and the sealant resin layer without using an anchor coating agent containing an isocyanate compound, a urethane resin, and/or an ethylene vinyl acetate copolymer resin (EVA), etc.

In addition, when the sealant resin layer is formed to indirectly contact the substrate layer via the intermediate resin layer (second embodiment), the intermediate resin layer may be configured to contain an epoxidized fatty acid or a derivative thereof, but in this situation too, the sealant resin layer may contain an epoxidized fatty acid or a derivative thereof.

Examples of the epoxidized fatty acid or a derivative thereof include epoxidized animal oil or vegetable oil, e.g., epoxidized soybean oil (ESO), epoxidized propylene glycol dioleate, epoxidized corn oil, epoxidized sunflower oil, epoxidized palm oil, epoxidized linseed oil, epoxidized canola oil, epoxidized rapeseed oil, epoxidized safflower oil, epoxidized tall oil, epoxidized tung oil, epoxidized castor oil, epoxidized methylstearate, epoxidized butylstearate, epoxidized 2-ethylhexylstearate, epoxidized stearylstearate, 3,4-epoxycyclohexylmethyl-3,4-epoxycyclohexanecarboxylate epoxidized soybean oil, epoxidized fatty acid methyl ester, etc. The foregoing may be used alone or as a combination of two or more.

Among the foregoing, epoxidized soybean oil is preferable. When the epoxidized soybean oil is subjected to pressurized methanolysis and the obtained soluble portion is reacted with a TMAH reagent and analyzed by GC-MS, peaks are detected as epoxy oleic acid.

In terms of being able to reliably increase the adhesiveness between the substrate layer and the intermediate resin layer or the sealant resin layer without using an anchor coating agent and being able to better suppress reductions in transparency, the epoxidized fatty acid or a derivative thereof is preferably at a content of 0.5 parts by mass or less, more preferably 0.3 parts by mass or less, and even more preferably 0.2 parts by mass or less with respect to 100 parts by mass of the resin component constituting the intermediate resin layer contacting the substrate layer or the sealant resin layer contacting the substrate layer. The lower limit value is 0.00001 parts by mass or more, preferably 0.00002 parts by mass or more, more preferably 0.0001 parts by mass or more, and even more preferably 0.001 parts by mass or more.

(Anti-Static Agent)

In the cover film according to the present embodiment, the surface of the substrate layer on the side not contacting the intermediate resin layer or the sealant resin layer (the surface of the substrate layer opposite the side contacting the intermediate resin layer or the sealant resin layer; the outermost surface on the substrate layer side of the cover film) or the surface of the sealant resin layer on the side not contacting the intermediate resin layer or the substrate layer (the surface of the sealant resin layer opposite the side contacting the intermediate resin layer or the substrate layer; the outermost surface on the sealant resin layer side of the cover film) may be subjected to an anti-static treatment. The surface that has undergone the anti-static treatment contains an anti-static agent. Examples of the anti-static agent include surfactants such as those that are anion-based, cation-based, non-ionic, or betaine-based; electrically conductive materials such as carbon black, titanium oxide, zinc oxide, tin oxide dispersed in a binder resin; etc. A thermoplastic resin can be used as the binder resin. As the thermoplastic resin, a polyurethane-based resin, an acrylic resin, a polyvinyl chloride-based resin, an ethylene-vinyl acetate-based resin, a polyester-based resin, a butadiene-based resin, a styrene-based resin, or an acrylic modified polyester resin can be suitably used. In terms of workability, it is preferable that a resin identical to that of the sealant resin layer or the intermediate resin layer in which the anti-static agent is added be used.

Examples of the anti-static treatment include a method involving applying an anti-static agent to a surface of the substrate layer by a spray, a lip coater, a roll coater using a gravure roll, etc.; a method involving preliminarily mixing an anti-static agent in the resin constituting the substrate layer or the sealant resin layer; etc.

On the sealant resin layer or the substrate layer that has undergone the anti-static treatment with the method involving applying an anti-static agent, a layer containing the anti-static agent (anti-static layer) is formed. The anti-static layer preferably has an average thickness of 0.05-10 μm and more preferably 0.1-5 μm. The average thickness here refers to the average thickness after drying. By setting the average thickness of the anti-static layer within the above ranges, it is possible to reduce the surface resistivity of the cover film surface while maintaining the transparency of the cover film. In order to uniformly apply the anti-static agent, a corona discharge treatment or an ozone treatment is preferably performed on the substrate surface before the anti-static treatment is performed, and a corona discharge treatment is particularly preferred. In addition, the “average thickness” of the anti-static layer is the average value of measurements made at five points from a sectional observation using a scanning electron microscope (SEM).

In the method involving preliminarily mixing an anti-static agent in the resin constituting the substrate layer or the sealant resin layer, the amount of the anti-static agent mixed is preferably 5-30 parts by mass and more preferably 10-25 parts by mass with respect to 100 parts by mass of the resin component.

The surface resistivity of the surface that has undergone the anti-static treatment can be, e.g., 1×10¹³Ω/□ or less, 1×10¹²Ω/□ or less, 1×10⁹Ω/□ or less, or 1×10⁷Ω/□ or less. The surface resistivity is preferably 1×10¹³Ω/□ or less.

(Cover Film)

In the present embodiment, the cover film preferably has an average thickness of 30-100 μm, more preferably 35-80 μm, and even more preferably 40-70 μm. By setting the average thickness of the cover film to 30 μm or more, it is possible to prevent tearing when the cover film is peeled. Meanwhile, by setting the average thickness of the cover film to 100 μm or less, not only is it possible to suppress increased costs but it is also possible to improve productivity by shortening sealing time. In addition, the “average thickness” of the cover film is the average value of measurements made at five points using a PEACOCK precision measuring instrument manufactured by OZAKI MFG. CO. LTD.

The cover film preferably has an adhesive strength of 1.5 N/15 mm or more and more preferably 3.0 N/15 mm or more between the substrate layer and the sealant resin layer. The adhesive strength is a value obtained by cutting a laminated body into a 15 mm-wide oblong shape in the flow direction, peeling at the layer interface between the substrate layer and the sealant resin layer formed in contact with one surface of the substrate layer or the intermediate resin layer formed in contact with one surface of the substrate layer, and measuring at a peel speed of 300 mm/min in accordance with the T-peel test (EZ-TEST manufactured by SHIMADZU).

The cover film preferably has a haze increase rate of 20% or less and more preferably 10% or less with respect to a reference film that is free of epoxidized fatty acids or derivatives thereof in the intermediate resin layer and the sealant resin layer. For cover films having a substrate layer, an intermediate resin layer, and a sealant resin layer, a reference film, which is free of epoxidized fatty acids or derivatives thereof in the intermediate resin layer and the sealant resin layer, and a film for evaluation, which contains an epoxidized fatty acid or a derivative thereof in the intermediate resin layer, are prepared, the haze value of each film is measured with a haze meter (NDH7000 manufactured by Nippon Denshoku), and the haze increase rate is calculated as an increase rate in the haze value of a film for evaluation relative to a reference film.

The present embodiment can increase the adhesiveness between the substrate and the intermediate resin layer or the sealant resin layer without using an anchor coating agent, but this does not exclude embodiments using an anchor coating agent. That is, in one embodiment, the cover film may contain an anchor coating agent component.

Meanwhile, in one embodiment, the cover film can also adopt a configuration free of anchor coating agents. For example, the cover film can adopt a configuration that does not substantially use an isocyanate compound and/or a urethane resin (e.g., the content of the isocyanate compound and/or the urethane resin is 5 mass % or below in the entire resin component).

Method for Producing Cover Film

The method for making the cover film is not particularly limited and any general method can be used. For example, a laminated film with the substrate layer may be made by extruding the intermediate resin layer and the sealant resin layer of the present invention from a T-die onto a surface of a biaxially stretched polyester film of the substrate layer. Further, when an anti-static layer is included, the target cover film can be obtained by coating the sealant resin layer with a resin composition constituting the anti-static layer with, for example, a gravure coater, a reverse coater, a kiss coater, an air knife coater, a Mayer bar coater, a dip coater, etc. The cover film according to the present embodiment does not require the use of an anchor coating agent, so the application step of the anchor coating agent can be omitted, and environmental issues caused by the organic solvent contained in the anchor coating agent do not occur either.

As another method, a film containing a substrate layer and a sealant resin layer can also be obtained by preliminarily film-forming the sealant resin layer by a T-die casting method, an inflation method, etc. and adhering this to the substrate layer by a dry lamination method.

In addition to the abovementioned steps, an anti-static layer can be formed by on the sealant resin layer as necessary. The anti-static layer can be formed by applying a composition containing an anti-static agent with a spray, a lip coater, or a roll coater using a gravure roll, etc.

Use

The cover film can be used as a lid material of a carrier tape, which is a storage container for electronic components. A carrier tape is a belt-like article with a width from about 8 to 100 mm having pockets for storing electronic components. In cases in which the cover film is heat sealed as a lid material, the material constituting the carrier tape is not particularly limited and commercially available materials can be used. For example, polystyrene, polyesters, polycarbonates, polyvinyl chlorides, etc. can be used. For the carrier tape, materials to which electrical conductivity has been imparted by kneading carbon black or carbon nanotubes in a resin, materials in which an anti-static agent or electrically conductive material has been kneaded, or materials in which anti-static properties have been imparted by applying to the surface thereof a coating liquid in which a surfactant-type anti-static agent or an electrically conductive substance such as polypyrrole or polythiophene is dispersed in an organic binder such as acrylic can be used.

Packages in which electronic components have been stored are obtained by, for example, storing an electronic component, etc. in an electronic component storage part of a carrier tape, then making a cover film into a lid material, packaging by continuously heat sealing both edges of the cover film in the longitudinal direction thereof, and winding on a reel. Electronic components, etc. can be stored and transported by packaging in this form. While transporting a package in which electronic components, etc. have been stored using holes, called sprocket holes, for carrier tape transport that are provided on the edges of the carrier tape in the longitudinal direction thereof, the cover film is intermittently peeled and the presence, orientation, and position of the electronic components, etc. are confirmed while these are extracted by a component mounting device and mounted on substrates.

### EXAMPLES

The present invention is explained in detail below using examples, but the present invention is not limited thereby. The various materials used in the examples and comparative examples are as follows.

(Substrate Layer)

Biaxially stretched polyethylene terephthalate film: “E-5100” manufactured by TOYOBO CO., LTD., thickness: 16 μm

(Intermediate Resin Layer)

m-LLDPE: Linear low-density polyethylene polymerized with a metallocene-based catalyst, “Umerit 2040F” manufactured by UBE-MARUZEN POLYETHYLENE) (density: 0.918 g/cm³ by JIS K7112)

(Sealant Resin Layer)

Styrene-butadiene-styrene triblock copolymer hydrogenated resin: “Tuftec H1041” manufactured by Asahi Kasei Corporation

Styrene-butadiene block copolymer 1: “DENKA CLEAREN” manufactured by Denka Company Limited.

Styrene-butadiene block copolymer 2: “TR Resin” manufactured by JSR Corporation

Ethylene-1-butene random copolymer: “Tafmer-A” manufactured by Mitsui Chemicals, Inc.

High-impact polystyrene: “E640N” manufactured by TOYO-STYRENE CO., LTD.

Ethylene-vinyl acetate copolymer: “Everflex V5711” manufactured by DuPont-Mitsui Polychemicals Co. Ltd.

Talc-silica masterbatch: “PEX-ABT-16” manufactured by TOYO INK CO., LTD.

Epoxidized soybean oil: “O-130P” manufactured by ADEKA CORPORATION

### Example 1

A cover film with a three-layer structure having a substrate layer, an intermediate resin layer, and a sealant resin layer in this order was made as follows. As a resin constituting the sealant resin layer, 100 parts by mass of a hydrogenated resin of a styrene-butadiene-styrene triblock copolymer (“Tuftec H1041” manufactured by Asahi Kasei Chemicals Corporation, olefin component content: 70 mass %) and 25 parts by mass of a talc and silica masterbatch (“PEX-ABT-16” manufactured by TOKYO PRINTING INK MFG CO., LTD., olefin component content: 50 mass %) were pre-blended in a tumbler and a single-screw extruder was used to obtain a 20 μm-thick sealant film. Between this sealant film and a biaxially stretched polyethylene terephthalate film (16 μm-thick), a resin, in which 100 parts by mass of a metallocene-based linear low-density polyethylene (“Umerit 2040F” manufactured by UBE-MARUZEN POLYETHYLENE), which is a resin constituting the intermediate resin layer and 0.25 parts by mass of an epoxidized soybean oil (“O-130” manufactured by ADEKA CORPORATION) were blended in a tumbler, was extruded at a thickness of 13 μm with a single-screw extruder and laminated by an extrusion lamination method to obtain a cover film for an electronic component carrier tape. In this case, no anchor coating agent or adhesive is used.

### Examples 2-6, 8, and 9 and Comparative Examples 1 and 2

Aside from using the materials and compositions shown in Table 1, cover films were obtained by the same method as Example 1. In addition, Comparative Examples 1 and 2 are examples of cases of cover films with a three-layer structure in which the intermediate sealant resin layer contacting the substrate layer is free of epoxidized fatty acids or derivatives thereof.

### Example 7

A cover film with a two-layer structure having a substrate layer and a sealant resin layer in this order was made as follows. As a resin constituting the sealant resin layer, 100 parts by mass of a hydrogenated resin of a styrene-butadiene-styrene triblock copolymer (“Tuftec H1041” manufactured by Asahi Kasei Chemicals Corporation, olefin component content: 70 mass %) and 25 parts by mass of a talc and silica masterbatch (“PEX-ABT-16” manufactured by TOKYO PRINTING INK MFG CO., LTD., olefin component content: 50 mass %), and 0.156 parts by mass of an epoxidized soybean oil (“0-130” manufactured by ADEKA CORPORATION) were blended in a tumbler and using a single-screw extruder, were extruded onto a biaxially stretched polyethylene terephthalate film (16 μm-thick) to coat as a 20 μm-thick sealant film to obtain a cover film for an electronic component carrier tape. In this case, no anchor coating agent or adhesive is used.

### Comparative Example 3

Aside from using the composition shown in Table 1 without mixing an epoxidized soybean oil in the sealant resin layer, a cover film was obtained by the same method as Example 7.

Measurement and Evaluation Methods

Measurements were made by the methods shown below and evaluation was carried out on the basis of the criteria shown below for the cover film for an electronic component carrier tape made in each of the examples and comparative examples. The results thereof are collectively shown in Table 1.

(Interlayer Adhesive Strength)

The laminated bodies obtained by the above process were left to stand for 24 hours at a temperature of 23° C. in an atmosphere with a relative humidity of 50%, then cut into 15 mm-wide oblong shapes in the resin flow direction. The peel strength was measured and evaluated according to the following criteria by peeling at the layer interface (Example 7 and Comparative Example 3) between the substrate layer and the sealant resin layer formed in contact with one surface of the substrate layer or at the layer interface (Examples 1-6, 8, and 9 and Comparative Examples 1 and 2) between the substrate layer and the intermediate resin layer formed in contact with one surface of the substrate layer by using a T-peel tester (EZ-TEST manufactured by SHIMADZU) at a speed of 300 mm/min and also at a temperature of 23° C. in an atmosphere with a relative humidity of 50%.

4: 3.0 N/15 mm or more

3: 1.5 N/15 mm or more and less than 3.0 N/15 mm

2: 1.0 N/15 mm or more and less than 1.5 N/15 mm

1: less than 1.0 N/15 mm

(Haze Increase Rate)

The obtained laminated bodies were cut into squares 50 mm on each side, and haze values were evaluated under the measurement conditions of JIS K7136 using a haze meter (NDH7000 manufactured by Nippon Denshoku). The haze increase rate was a value obtained by the equation: haze increase rate (%)=(1−(B/A))×100, where A is the haze value of a laminated body containing an epoxidized fatty acid or a derivative thereof and B is the haze value of a laminated body that has the same composition and configuration but is free of epoxidized fatty acids or derivatives thereof. Evaluation was made according to the criteria below.

4: 10% or less

3: 11% or more and 20% or less

2: 21% or more and 30% or less

1: 31% or more

TABLE 1

| | | | | | | | | | | | Comp. | Comp. | Comp. |
|---|---|---|---|---|---|---|---|---|---|---|---|---|---|
| Type of Resin | | Ex. 1 | Ex. 2 | Ex. 3 | Ex. 4 | Ex. 5 | Ex. 6 | Ex. 7 | Ex. 8 | Ex. 9 | Ex.1 | Ex.2 | Ex.3 |
| Substrate | PET | 100 | 103 | 100 | 100 | 100 | 100 | 100 | 100 | 100 | 100 | 100 | 100 |
| layer | | | | | | | | | | | | | |
| Intermediate | m-LLDPE | 100 | 100 | 100 | 100 | 100 | 100 | | 100 | 100 | 100 | 100 | |
| resin layer | Epoxidated | 0.25 | 0.125 | 0.5 | 0.00002 | 0.125 | 0.125 | | 0.00001 | 0.76 | | | |
| | soybean oil | | | | | | | | | | | | |
| Sealant resin | Styrene-butadiene- | 100 | 100 | 100 | 100 | | | 100 | 100 | 100 | 100 | | 100 |
| layer | styrene triblock | | | | | | | | | | | | |
| | copolymer | | | | | | | | | | | | |
| | hydrogenated resin | | | | | | | | | | | | |
| | Styrene-butadiene | | | | | 42.5 | | | | | | 43.5 | |
| | block copolymer 1 | | | | | | | | | | | | |
| | Styrene-butadiene | | | | | 12.5 | | | | | | 12.5 | |
| | block copolymer 2 | | | | | | | | | | | | |
| | Ethylene-1-butene | | | | | 35 | | | | | | 35 | |
| | random copolymer | | | | | | | | | | | | |
| | High-impact | | | | | 10 | | | | | | 10 | |
| | polystyrene | | | | | | | | | | | | |
| | Ethylene-vinyl | | | | | | 100 | | | | | | |
| | acetate copolymer | | | | | | | | | | | | |
| | Talc-silica | 25 | 25 | 25 | 25 | | | 25 | 25 | 25 | 25 | | 25 |
| | masterbatch | | | | | | | | | | | | |
| | Epoxidized | | | | | | | 0.156 | | | | | |
| | soybean oil | | | | | | | | | | | | |
| Adhesive | N/15 mm | 5.0 | 3.5 | 6.6 | 2.5 | 6.8 | 6.0 | 2.3 | 1.4 | 7.5 | 0.7 | 0.9 | 0.5 |
| strength | Evaluation | 4 | 4 | 4 | 3 | 4 | 4 | 3 | 2 | 4 | 1 | 1 | 1 |
| Haze | % | 15 | 13 | 18 | 7 | 14 | 14 | 18 | 5 | 27 | 0 | 0 | 0 |
| increase | Evaluation | 3 | 3 | 3 | 4 | 3 | 3 | 3 | 4 | 2 | 4 | 4 | 4 |
| rate | | | | | | | | | | | | | |

Content unit: parts by mass

### REFERENCE SIGNS LIST

10, 20, 30 Cover film
11, 21, 31 Substrate layer
12, 22, 32a, 32b Sealant resin layer
23, 33 Intermediate resin layer

1. A cover film having at least a substrate layer and a sealant resin layer,
wherein the sealant resin layer is formed in contact with one surface of the substrate layer or is formed on an intermediate resin layer contacting one surface of the substrate layer, and
the sealant resin layer contacting the substrate layer or the intermediate resin layer contacting the substrate layer comprises an epoxidized fatty acid or a derivative thereof.

2. The cover film of claim 1, wherein the epoxidized fatty acid or a derivative thereof in the sealant resin layer contacting the substrate layer or in the intermediate resin layer contacting the substrate layer is at a content of 0.5 parts by mass or less with respect to 100 parts by mass of a resin component constituting the sealant resin layer contacting the substrate layer or the intermediate resin layer contacting the substrate layer.

3. The cover film of claim 1, wherein the intermediate resin layer comprises a polyethylene resin.

4. The cover film of claim 3, wherein the polyethylene resin has a density of 0.85-0.95 g/cm³ as measured in accordance with a JIS K7112 measurement method.

5. The cover film of claim 1, wherein the sealant resin layer comprises one or more selected from the following [1] to [3]:
[1] a resin composition that comprises a styrene-diene block copolymer-containing styrene-based resin and an ethylene-α-olefin random copolymer
[2] a hydrogenated product of an aromatic vinyl-conjugated diene copolymer comprising 15-45 mass % of an aromatic vinyl-derived monomer unit
[3] an ethylene-vinyl acetate copolymer comprising 70-91 mass % of an olefin component.

6. The cover film of claim 1, wherein the substrate layer comprises one or more selected from a biaxially stretched polyester and a biaxially stretched polypropylene.

7. The cover film of claim 1, wherein a surface of the substrate layer, which does not contact the sealant resin layer or the intermediate resin layer, and/or a surface of the sealant resin layer, which does not contact the substrate layer or the intermediate layer, comprises an anti-static agent.

8. The cover film of claim 7, wherein the anti-static agent comprises one or more selected from a surfactant, tin oxide, zinc oxide, titanium oxide, and carbon black, and the surface comprising the anti-static material has a surface resistance of 1×10¹³Ω/□ or less.

9. A lid material for a carrier tape comprising a thermoplastic resin, the lid material comprising the cover film of claim 1.

10. An electronic component package having: a lid material using the cover film of claim 1; and carrier tape using a thermoplastic resin.
